(19) United States
(12) Patent Application Publication
(10) Pub. No.: US 2015/0180615 A1
(43) Pub. Date: Jun. 25, 2015

(54) POWER GRANT USE FOR HARQ RETRANSMISSION

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/139,639

(22) Filed: Dec. 23, 2013

(51) Int. Cl. H04L 1/18

(52) U.S. Cl. CPC H04L 1/1822; H04L 1/1887

(57) ABSTRACT

A method of wireless communication includes determining when all HARQ processes are associated with packages for retransmission. The method also includes determining when no new packages are pending in a UE buffer and when a received grant is insufficient for retransmission of any of the HARQ processes. The method further includes determining possible block sizes supported by each allocated time slot identified in the received grant. The method still further includes retransmitting the package of a selected HARQ process with maximum available power.

### BACKGROUND

1. Field

Aspects of the present disclosure relate generally to wireless communication systems, and more particularly, to power grant use for hybrid automatic repeat request (HARQ) retransmissions.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes determining when all HARQ processes are associated with packages for retransmission. The method also includes determining when no new packages are pending in a UE buffer. The method further includes determining when a received grant is insufficient for retransmission of any of the HARQ processes. The method still further includes determining possible block sizes supported by each allocated time slot identified in the received grant. The method still yet further includes retransmitting the package of a selected HARQ process with maximum available power.

Another aspect discloses an apparatus including means for determining when all HARQ processes are associated with packages for retransmission. The apparatus also includes means for determining when no new packages are pending in a UE buffer. The apparatus further includes means for determining when a received grant is insufficient for retransmission of any of the HARQ processes. The apparatus still further includes means for determining possible block sizes supported by each allocated time slot identified in the received grant. The apparatus still yet further includes means for retransmitting the package of a selected HARQ process with maximum available power.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining when all HARQ processes are associated with packages for retransmission. The program code also causes the processor(s) to determine when no new packages are pending in a UE buffer. The program code further causes the processor(s) to determine when a received grant is insufficient for retransmission of any of the HARQ processes. The program code still further causes the processor(s) to determine possible block sizes supported by each allocated time slot identified in the received grant. The program code still yet further causes the processor(s) to retransmit the package of a selected HARQ process with maximum available power.

Another aspect discloses wireless communication having a memory and at least one processor coupled to the memory. The processor(s) is configured to determine when all HARQ processes are associated with packages for retransmission. The processor(s) is also configured to determine when no new packages are pending in a UE buffer. The processor(s) is further configured to determine when a received grant is insufficient for retransmission of any of the HARQ processes. The processor(s) is still further configured to determine possible block sizes supported by each allocated time slot identified in the received grant. The processor(s) is still yet further configured to retransmit the package of a selected HARQ process with maximum available power.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates an example of power grant use for HARQ retransmissions.

FIG. 5 is a block diagram illustrating a method for power grant use for HARQ retransmissions according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

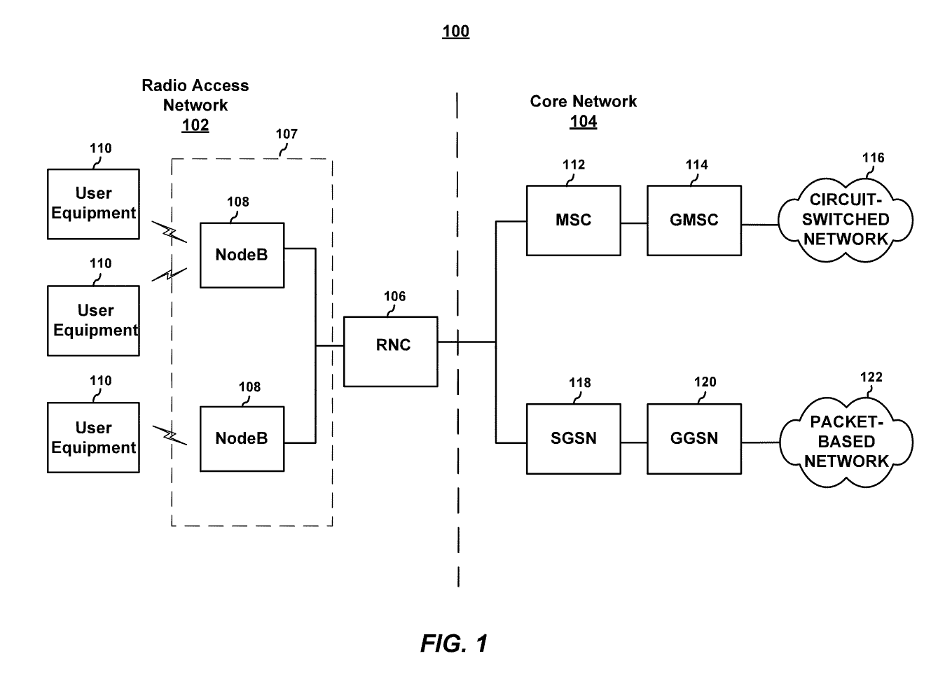

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General packet radio service (GPRS) is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

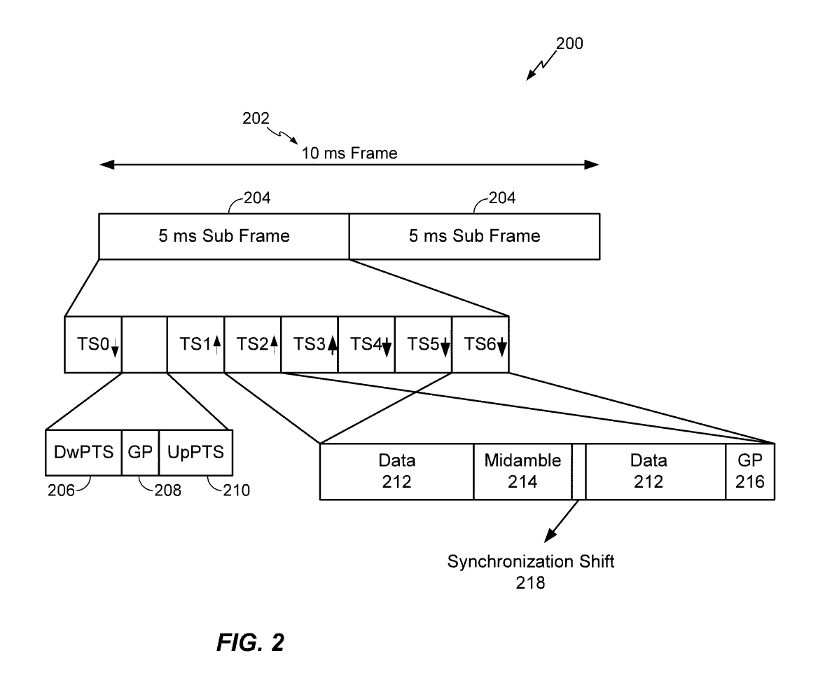

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

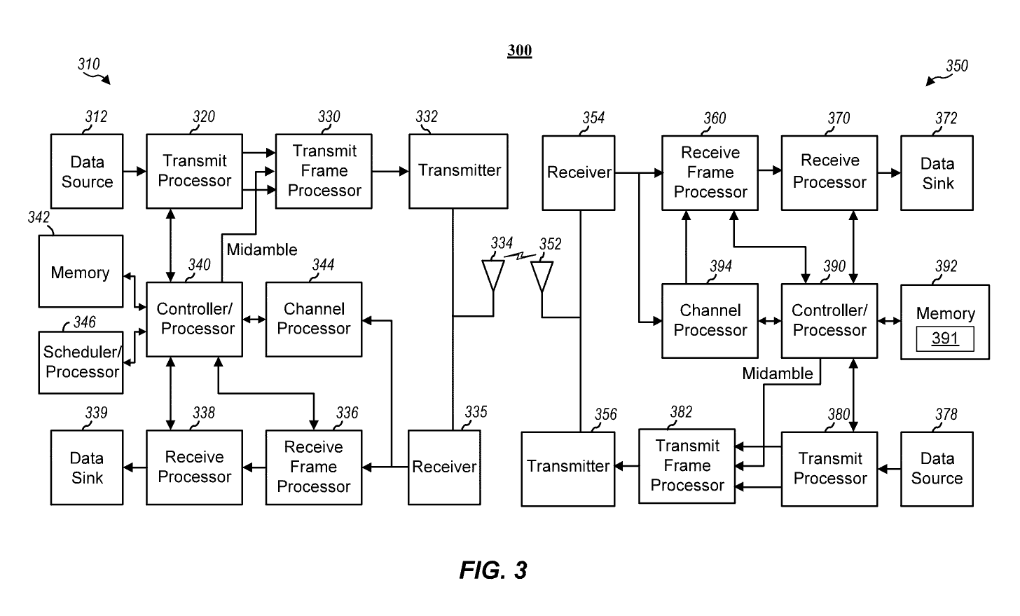

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store the HARQ retransmission module 391 which, when executed by the controller/processor 390, configures the UE 350 for retransmitting HARQ processes regardless of a transmission power identified in a received grant. A scheduler/processor 346 at the node B 310 may be used to allocate resources to the UEs and schedule downlink and/or uplink transmissions for the UEs.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic. The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps.

Resource Request: First, the UE sends requests (e.g., via scheduling information (SI)) via the E-PUCH or the E-RUCCH to a base station (e.g., NodeB). The requests are for permission to transmit on the uplink channels.

Resource Allocation: Second, the base station, which controls the uplink radio resources, allocates resources. Resources are allocated in terms of scheduling grants (SGs) to individual UEs based on their requests.

UE Transmission: Third, the UE transmits on the uplink channels after receiving grants from the base station. The UE determines the transmission rate and the corresponding transport format combination (TFC) based on the received grants. The UE may also request additional grants if it has more data to transmit.

Base Station Reception: Fourth, a hybrid automatic repeat request (hybrid ARQ or HARQ) process is employed for the rapid retransmission of erroneously received data packets between the UE and the base station.

The transmission of scheduling information (SI) may consist of two types in TD-HSUPA: (1) In-band and (2) out-of-band. For in-band, which may be included in medium access control e-type protocol data unit (MAC-e PDU) on the E-PUCH, data can be sent standalone or may piggyback on a data packet. For out-of-band, data may be sent on the E-RUCCH in case that the UE does not have a grant. Otherwise, the grant expires.

Scheduling information (SI) includes the following information or fields. The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity are not included in the TEBS. The actual value of the TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by the HLID, relative to the highest value of the buffer size reported by the TEBS. In one configuration, this report is generated when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power. The serving neighbor path loss (SNPL) reports the path loss ratio between the serving cells and the neighboring cells. The base station scheduler incorporates the SNPL for inter-cell interference management tasks to avoid neighbor cell overload.

### Improving Power Grant Use for HARQ Retransmissions

In a typical system, such as TD-HSUPA, one hybrid automatic repeat request (HARQ) entity is specified for a UE. A number of parallel HARQ processes identified by a HARQ process identifier may be used to support the HARQ entity. For example, parallel HARQ processes may be used by the UE for continuous transmissions while the UE is granted resources. That is, a HARQ process is for a transmission in response to receiving the grant.

Specifically, the HARQ entity identifies a HARQ process that may be transmitted when resources are available via a grant. Additionally, based on a timing of a previously-transmitted MAC-e protocol data unit (PDU), the HARQ entity routes the receiver feedback (ACK/NACK information), relayed by the physical layer, to the appropriate HARQ process.

The HARQ entity may determine a specific HARQ process that may use the resources assigned in a grant for a given transmission time interval (TTI). The HARQ entity may also determine whether new data or existing data should be transmitted from the HARQ process buffer for each HARQ process.

In a typical system, when a UE receives a grant, the HARQ entity determines whether the HARQ process buffers are empty. When the buffers of all of the HARQ processes are empty, the HARQ entity notifies the transport format combination for E-DCH (E-TFC) selection entity that the next transmission time interval is available for a new transmission.

In one configuration, when the transport format combination for E-DCH selection entity indicates that a new E-DCH data transmission is specified, the UE selects a HARQ ID; obtains the transmission information from the transport format combination for E-DCH selection entity; and instructs the selected HARQ process to trigger new transmission. Alternatively, when the transport format combination for E-DCH selection entity does not indicate a new E-DCH data transmission, the UE selects a HARQ ID and instructs the selected HARQ process to trigger the transmission of scheduling information.

In another configuration, when the buffers of all HARQ processes are not empty, for example, when retransmissions are pending for any of the HARQ processes, the HARQ entity determines, for each HARQ process, whether a current resource grant is sufficient to allow retransmission of the data. In the present configuration, the grant is sufficient when a determined transport block size is supported by the time slot(s) specified in the grant. The transport block size may be determined based on the transmission power specified in the grant. Moreover, in the present configuration, when the grant is sufficient for retransmission of one of the HARQ processes, the HARQ process including the oldest MAC-e may be selected for retransmission. Alternatively, in the present configuration, when the grant is not sufficient for retransmission by the HARQ processes, the HARQ entity selects an available HARQ process for a new transmission. Still, when a HARQ process is not available for a new transmission, such as when all of the HARQ processes include data for a retransmission, the HARQ entity discards the data from the HARQ process including the oldest MAC-e and selects the HARQ process with the discarded data for a new transmission.

In a typical system, when a UE receives a grant, the UE is specified to use the grant to transmit a HARQ process. As previously discussed, when all of the HARQ processes are waiting for grants to perform a retransmission, and a transport block size of a grant is not sufficient for retransmission by any of the available HARQ processes, the HARQ entity selects an available HARQ process for a new transmission. Still, when there is no new data in UE buffer, the UE discards a HARQ process with the oldest PDU to free the oldest HARQ process. Furthermore, when there is no new data in the buffer, the UE transmits a zero bit payload with the scheduling information and/or padding. The throughput may decrease as a result of transmitting the zero bit payload with the scheduling information and/or padding.

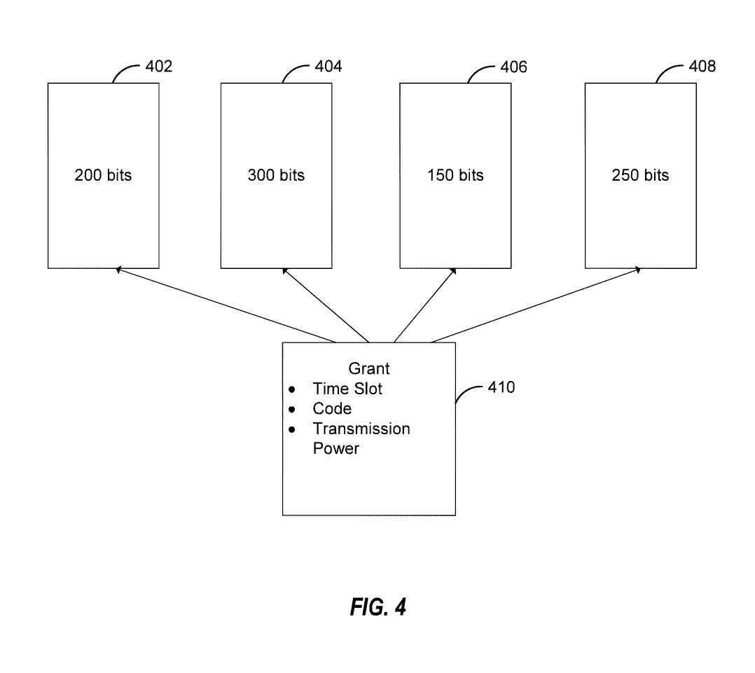

FIG. 4 illustrates an example of HARQ processes. As shown in FIG. 4, four HARQ processes 402-408 may be specified for a UE. Specifically, the first HARQ process 402 has a transmission block size of 200 bits, the second HARQ process 404 has a transmission block size of 300 bits, the third HARQ process 406 has a transmission block size of 140 bits, and the fourth HARQ process 408 has a transmission block size of 240 bits. The block sizes shown in FIG. 4 are examples of possible block sizes. The present disclosure is not limited to the block sizes of FIG. 4.

In the present example, each HARQ process 402-408 has received a NAK from a base station in response to data transmission from each HARQ process 402-408. Therefore, each HARQ process 402-408 is waiting for a grant to perform a retransmission. Furthermore, while the HARQ processes 402-408 are waiting for a grant, the UE may receive a grant 410. The grant 410 may include a transmission time slot, a transmission code, and a transmission power. The UE may determine how many bits may be transmitted at the specified time slot based on the transmission power assigned in the grant.

Thus, in the example shown in FIG. 4, the UE receives a grant 410 when all of the HARQ processes 402-408 are waiting for a retransmission. That is, none of the HARQ processes are designated for new transmissions. According to the current standards, the UE must use a grant when a grant is received. Thus, in the present example, when the UE receives a grant, the UE determines whether the time slot specified in the grant can support the retransmission of one of the HARQ processes at the transmission power specified in the grant.

In one example, based on the transmission power identified in the grant, the UE may determine that it may only transmit a specific number of bits, such as 40 bits, at the specified time slot. Thus, in the present example, when the HARQ processes 402-408 have a payload that exceeds the number of bits that may be transmitted, the UE may discard one of the HARQ processes 402-408 to transmit another HARQ process for new data. Still, in the present example, a new HARQ process (e.g., new data) is not specified for the UE. Therefore, the UE may only transmit a HARQ process with a zero bit payload. Alternatively, if the specified time slot supports the number of bits allocated to one of the HARQ processes, the UE will transmit the HARQ process having a number of bits equal to the number of bits supported for transmission at the specified time slot.

Still, it is desirable to mitigate a decrease in performance that may result from a UE transmitting the zero bit payload with the scheduling information and/or padding. Thus, according to an aspect of the present disclosure, a UE may determine all possible block sizes associated with a number of time slots in the received grant, and the UE may retransmit a selected HARQ process with a maximum available power when a block size of any of the HARQ processes matches one of the possible block sizes. That is, the UE may retransmit the HARQ process regardless of the transmit power specified in the grant when a specified time slot supports the block size of a HARQ process.

Specifically, in the present configuration, a UE may receive a grant when all of the HARQ processes are waiting for a grant to perform retransmission. The UE may determine whether the grant is sufficient for one or more of the HARQ retransmissions based on the transmission power, the transmission code, and the transmission time slot specified in the grant. When the grant is not sufficient and when there is no new data in UE buffer, the UE calculates the maximum transport block size (TBS) supported by the time slot specified in the grant based on a maximum power grant. In one configuration, the UE considers the maximum power grant as thirty one regardless of the transmission power received in the grant, e.g., via the enhanced access grant channel (E-AGCH). It should be noted that thirty one is the maximum allowed transmission power based on the current standard, still, the present disclosure is not limited to a maximum transmission power of thirty one and is contemplated for any maximum transmission power value specified in an applicable standard. Based on the present aspect of the disclosure, the UE increases the possibility for performing a retransmission instead of discarding the HARQ process and/or performing a new transmission with a zero bit payload.

In the present configuration, based on the example shown in FIG. 4, when the UE receives a grant 410, the UE determines if the time slot specified in the grant 410 may support one of the block sizes of one of the HARQ processes 402-408. Specifically, the UE determines whether the specified time slot can support the block size regardless of the transmission power specified in the grant 410. Thus, in the present configuration, when then specified time slot can support one or more of the block sizes of one of the HARQ processes 402-408, the UE performs a retransmission of one of the HARQ processes. In one configuration, when a block size of more than one HARQ process is supported by the specified time slot, the UE selects the HARQ process with the smallest block size for the retransmission. In another configuration, when a block size of more than one HARQ process is supported by the specified time slot, the UE selects the oldest HARQ process for the retransmission.

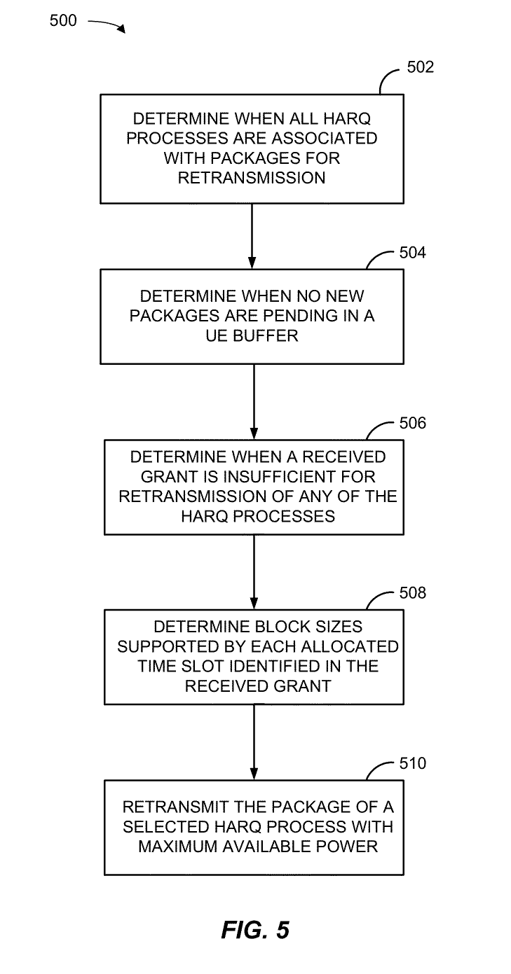

FIG. 5 shows a wireless communication method 500 according to one aspect of the disclosure. A UE determines when all HARQ processes are associated with packages (also referred to as PDUs, packets, or payloads) for retransmission as shown in block 502. The UE also determines when no new packages are pending in the UE's buffer as shown in block 504. Furthermore, as shown in block 506, the UE determines when a received grant is insufficient for retransmission of any of the HARQ processes. Additionally, as shown in block 508, the UE determines block sizes supported by each allocated time slot identified in the received grant. Finally, the UE retransmits the package of a selected HARQ process with maximum available power, as shown in block 510. That is, the package of the selected HARQ process is retransmitted when a block size of any of the HARQ processes matches one of the possible block sizes supported by a time slot specified in a grant.

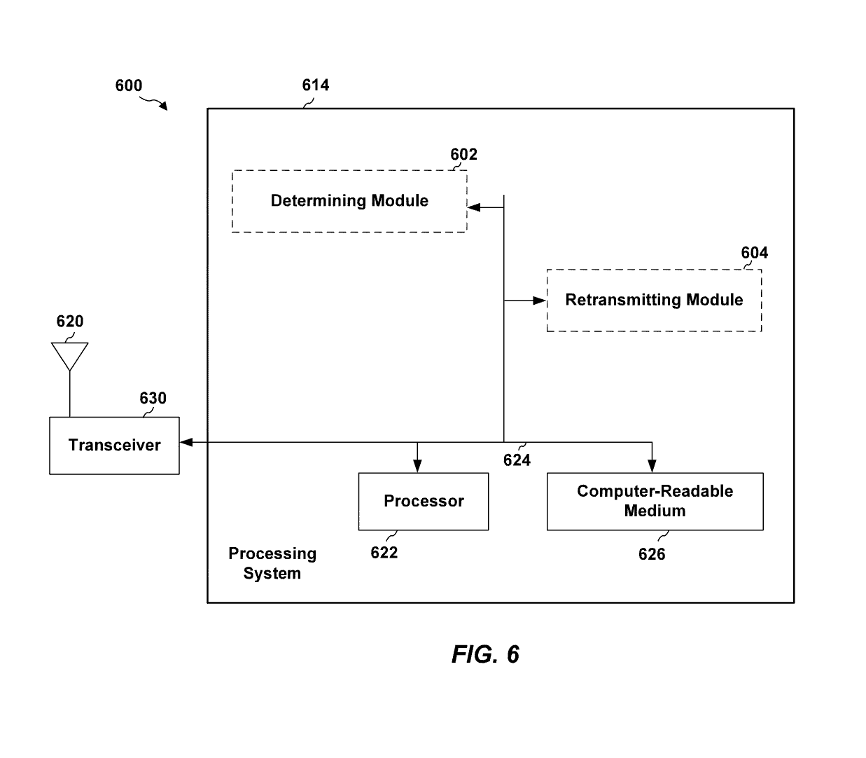

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a determining module 602 for determining when all HARQ processes are associated with packages for retransmission. The determining module 602 may be further configured to determine when no new packages are pending in a UE's buffer. Additionally, the determining module 602 may be further configured to determine when a received grant is insufficient for retransmission of any of the HARQ processes. Finally, the determining module 602 may also be configured to determine block sizes supported by each allocated time slot identified in the received grant. The determining module 602 may include distinct modules or may be one module as shown in FIG. 6. The processing system 614 includes a retransmitting module 604 for retransmitting the package of a selected HARQ process with maximum available power. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for determining. In one aspect, the determining means may be the transmit processor 380, the controller/processor 390, the memory 392, the HARQ retransmission module 391, determining module 602, and/or the processing system 614 configured to perform the determining means. The UE is also configured to include means for retransmitting. In one aspect, the retransmitting means may be the antennas 352, the transmitter 356, the transmit processor 380, the controller/processor 390, the memory 392, the HARQ retransmission module 391, retransmitting module 604 and/or the processing system 614 configured to perform the retransmitting means. In one aspect the means functions recited by the aforementioned means. In another aspect, the aforementioned means may be a module or any apparatus configured to perform the functions recited by the aforementioned means.

Several aspects of a telecommunications system has been presented with reference to TD-SCDMA and HSUPA systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining when all hybrid automatic repeat request (HARQ) processes are associated with packages for retransmission;
determining when no new packages are pending in a user equipment (UE) buffer;
determining when a received grant is insufficient for retransmission of any of the HARQ processes;
determining possible block sizes supported by each allocated time slot identified in the received grant; and
retransmitting the package of a selected HARQ process with maximum available power, when a block size of any of the HARQ processes matches one of the determined possible block sizes.

2. The method of claim 1, further comprising selecting a smallest block size for retransmission when more than one HARQ process matches one of the determined possible block sizes.

3. The method of claim 1, further comprising selecting an oldest HARQ process for the retransmission when more than one HARQ process matches one of the determined possible block sizes.

4. The method of claim 1, further comprising discarding an oldest HARQ process and performing a new transmission comprising a zero bit payload when none of the HARQ processes block sizes match one of the determined possible block sizes.

5. The method of claim 1, in which the grant includes one or more of a transmission time slot, a transmission code, a transmission power, or a combination thereof.

6. An apparatus for wireless communication, the apparatus comprising:
a memory unit; and
at least one processor coupled to the memory unit, the at least one processor being configured:
to determine when all hybrid automatic repeat request (HARQ) processes are associated with packages for retransmission;
to determine when no new packages are pending in a user equipment (UE) buffer;
to determine when a received grant is insufficient for retransmission of any of the HARQ processes;
to determine possible block sizes supported by each allocated time slot identified in the received grant; and
to retransmit the package of a selected HARQ process with maximum available power, when a block size of any of the HARQ processes matches one of the determined possible block sizes.

7. The apparatus of claim 6, in which the at least one processor is further configured to select a smallest block size for retransmission when more than one HARQ process matches one of the determined possible block sizes.

8. The apparatus of claim 6, in which the at least one processor is further configured to select an oldest HARQ process for the retransmission when more than one HARQ process matches one of the determined possible block sizes.

9. The apparatus of claim 6, in which the at least one processor is further configured to discard an oldest HARQ process and performing a new transmission comprising a zero bit payload when none of the HARQ processes block sizes match one of the determined possible block sizes.

10. The apparatus of claim 6, in which the grant includes one or more of a transmission time slot, a transmission code, a transmission power, or a combination thereof.

11. An apparatus for wireless communication, the apparatus comprising:
means for determining when all hybrid automatic repeat request (HARQ) processes are associated with packages for retransmission;
means for determining when no new packages are pending in a user equipment (UE) buffer;
means for determining when a received grant is insufficient for retransmission of any of the HARQ processes;
means for determining possible block sizes supported by each allocated time slot identified in the received grant; and
means for retransmitting the package of a selected HARQ process with maximum available power, when a block size of any of the HARQ processes matches one of the determined possible block sizes.

12. The apparatus of claim 11, further comprising means for selecting a smallest block size for retransmission when more than one HARQ process matches one of the determined possible block sizes.

13. The apparatus of claim 11, further comprising means for selecting an oldest HARQ process for the retransmission when more than one HARQ process matches one of the determined possible block sizes.

14. The apparatus of claim 11, further comprising means for discarding an oldest HARQ process and performing a new transmission comprising a zero bit payload when none of the HARQ processes block sizes match one of the determined possible block sizes.

15. The apparatus of claim 11, in which the grant includes one or more of a transmission time slot, a transmission code, a transmission power, or a combination thereof.

16. A computer program product for wireless communications, the computer program product comprising:
a non-transitory computer-readable medium having program code recorded thereon, the program code comprising:
program code to determine when all hybrid automatic repeat request (HARQ) processes are associated with packages for retransmission;
program code to determine when no new packages are pending in a user equipment (UE) buffer;
program code to determine when a received grant is insufficient for retransmission of any of the HARQ processes;
program code to determine possible block sizes supported by each allocated time slot identified in the received grant; and
program code to retransmit the package of a selected HARQ process with maximum available power, when a block size of any of the HARQ processes matches one of the determined possible block sizes.

17. The computer program product of claim 16, in which the program code further comprises program code to select a smallest block size for retransmission when more than one HARQ process matches one of the determined possible block sizes.

18. The computer program product of claim 16, in which the program code further comprises program code to select an oldest HARQ process for the retransmission when more than one HARQ process matches one of the determined possible block sizes.

19. The computer program product of claim 16, in which the program code further comprises program code to discard an oldest HARQ process and performing a new transmission comprising a zero bit payload when none of the HARQ processes block sizes match one of the determined possible block sizes.

20. The computer program product of claim 16, in which the grant includes one or more of a transmission time slot, a transmission code, a transmission power, or a combination thereof.
